(19) United States
(12) Patent Application Publication
(10) Pub. No.: US 2007/0156955 A1
(43) Pub. Date: Jul. 5, 2007

(54) Method and apparatus for queuing disk drive access requests

(76) Inventors: Robert J. Royer JR., Portland, OR (US); Michael K. Eschmann, Lees Summit, MO (US); Amber D. Huffman, Banks, OR (US); Knut S. Grimsrud, Forest Grove, OR (US); Sanjeev N. Trika, Hillsboro, OR (US); Brian M. Dees, Hillsboro, OR (US)

Correspondence Address: BUCKLEY, MASCHOFF & TALWALKAR LLC, 50 LOCUST AVENUE, NEW CANAAN, CT, 06840, US

(21) Appl. No.: 11/323,780

(22) Filed: Dec. 30, 2005

(51) Int. Cl. G06F 13/00

(52) U.S. Cl. 711/113

(57) ABSTRACT

A method includes receiving a request to access a disk drive. The request has a size. The method further includes selecting a queue, based at least in part on the size of the request, from among a plurality of queues, and assigning the request to the selected queue.

### BACKGROUND

It is increasingly the case that microprocessors run simultaneously two or more application programs. This may occur in a number of ways, including multithreaded processing, virtual machine software arrangements and/or provision of two or more processing cores in the microprocessor. When two or more applications run on the same device, there is a possibility that disk drive access may prove to be a bottleneck.

Consider for example a case in which two applications are running simultaneously on a microprocessor. Assume that one of the applications, running in background from the point of view of the user, is engaged in a task, such as backing up or copying a large file or multimedia transcoding, which requires large and frequent access to the disk drive. Further assume that the user is interacting with another application which requires only modest disk drive access. Because disk subsystems (drive and drivers) optimize disk operations to reduce seeks and rotational latencies, the first application may tend to be favored and the second application may be starved of disk drive access. This may lead to delays in the second application that are very extensive and unacceptable from the user's point of view.

### BRIEF DESCRIPTION OF THE DRAWINGS

FIG. 1 is a block diagram of a computer system according to some embodiments.

FIG. 2 schematically illustrates a queuing scheme performed by the system of FIG. 1 in accordance with some embodiments.

FIGS. 3A and 3B together form a flow chart that illustrates a queue-filling process that may be performed by the system of FIG. 1.

FIGS. 4A-4C together form a flow chart that illustrates a queue-servicing process that may be performed by the system of FIG. 1.

FIG. 5 is a flow chart that illustrates a process for responding to completion of servicing of a disk drive access request.

### DETAILED DESCRIPTION

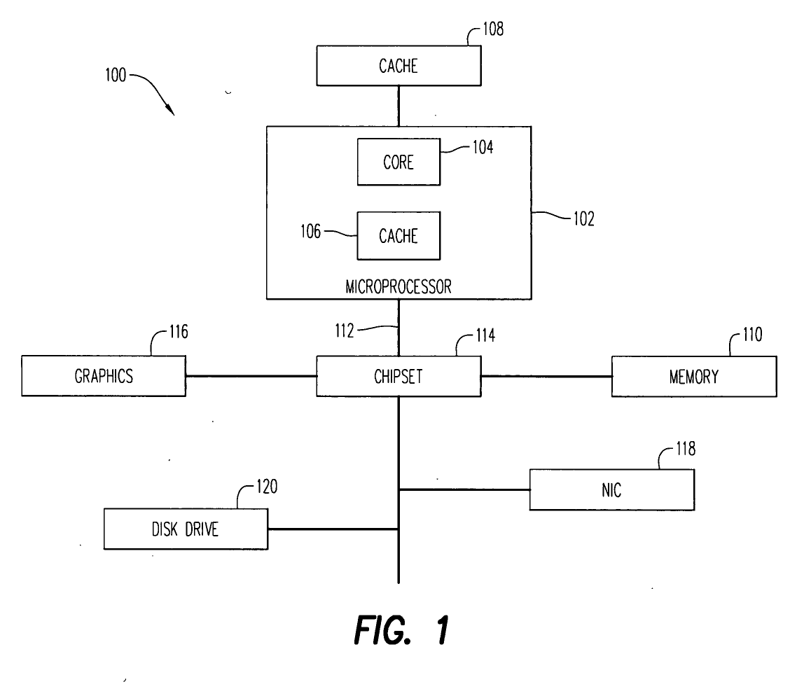

FIG. 1 is a block diagram of a computer system 100 provided according to some embodiments. The computer system 100 includes a microprocessor die 102, which, in turn, comprises many sub-blocks. The sub-blocks may include processing core 104 and on-die cache 106. (Although only one processing core is shown, the microprocessor may include two or more cores.) Microprocessor 102 may also communicate to other levels of cache, such as off-die cache 108. Higher memory hierarchy levels, such as system memory 110, are accessed via host bus 112 and chipset 114. In addition, other off-die functional units, such as graphics accelerator 116 and network interface controller (NIC) 118, to name just a few, may communicate with microprocessor 102 via appropriate buses or ports. The system 100 may also include a number of peripheral devices, such as disk drive 120 and other devices which are not shown. A suitable port (not separately shown) allows for communication between the core 104 and the disk drive 120, so that the disk drive may respond to disk access requests (for data storage or retrieval) from the core 104.

There will now be described certain strategies employed according to some embodiments of the computer system 100 to provide for efficient handling of disk access requests. These strategies may be employed, for example, as part of disk drive driver software that may control operation of at least a part of the microprocessor 102. These strategies may promote efficiency not necessarily in the sense of optimizing the operation of the disk drive 120 itself, but rather in promoting a satisfactory user experience with all applications running on the system.

According to one strategy, two queues are used for disk access requests, one for large requests and the other for small requests, with the small requests receiving preference in terms of actual service by the disk drive. The queue for the large requests may be referred to as the “low-priority queue” and the queue for the small requests may be referred to as the “high-priority queue”. Since applications that do not require media transcoding or playback are more likely to produce only small requests, the preference given to small requests may reduce the time required for accomplishment of tasks by such applications by reducing the likelihood that such tasks will be starved by large requests generated by another application operating in background. Moreover, when large requests are queued (e.g., when added to the low-priority queue) the requests may be broken up so as not to block new high-priority requests for an excessive amount of time while being serviced.

According to another strategy, intended to prevent the low-priority queue from being starved by servicing of the high-priority queue, a timing deadline may be established for the low-priority queue to establish a guaranteed quality of service for large requests.

According to still another strategy, there may be a limit to the number of low-priority requests that have been accepted for servicing from the low-priority queue and which remain pending in the disk queue. The purpose of limiting the number of pending low-priority requests is to assure reasonably prompt service for new small requests when they come in. The limit for the number of pending low-priority requests may be increased over times during which no small requests are received.

According to yet another strategy, the use of two or more queues may be suspended under some circumstances. For example, when there are very many small requests in the high-priority queue, the high- and low-priority queues may be merged to promote maximum efficiency of disk access operations during times of high demand for access.

There will now be described details of processes that may be performed in the computer system 100 to carry out some or all of these strategies for handling disk access requests.

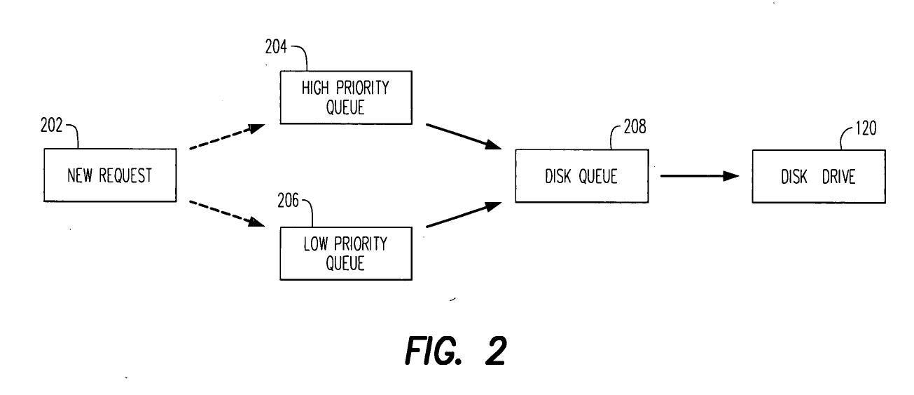

FIG. 2 schematically illustrates a queuing scheme performed by the system of FIG. 1 in accordance with some embodiments. As indicated in FIG. 2, when a new disk access request 202 is received, it is assigned either to the high priority queue 204 or to the low priority queue 206. The assignment decision is based on the size of the request (i.e., on the number of disk address locations to be accessed to service the request). In some embodiments, a request having a size that does not exceed (i.e., is equal to or less than) a threshold of 128 KB may be considered a small request and therefore assigned to the high-priority queue 204. In such embodiments, a request that has a size in excess of 128 KB may be considered a large request and assigned to the low-priority queue 206.

Servicing each queue may include taking requests off the queue and into a drive queue 208. Each request in the drive queue is serviced by the disk drive 120. Servicing of each request may be considered to include taking such request into the drive queue 208 and then performing the requested disk access operation (either storage or retrieval of data to or from the disk drive 120). Each of the high-priority queue 204 and the low-priority queue 206 may be sorted separately, and in accordance with conventional practices, to minimize the number of seek operations and the amount of rotational latency required for the requested disk accesses.

As will be understood from both previous and subsequent discussion, the queuing scheme illustrated in FIG. 2 may be interrupted at times when a high number of small requests are received.

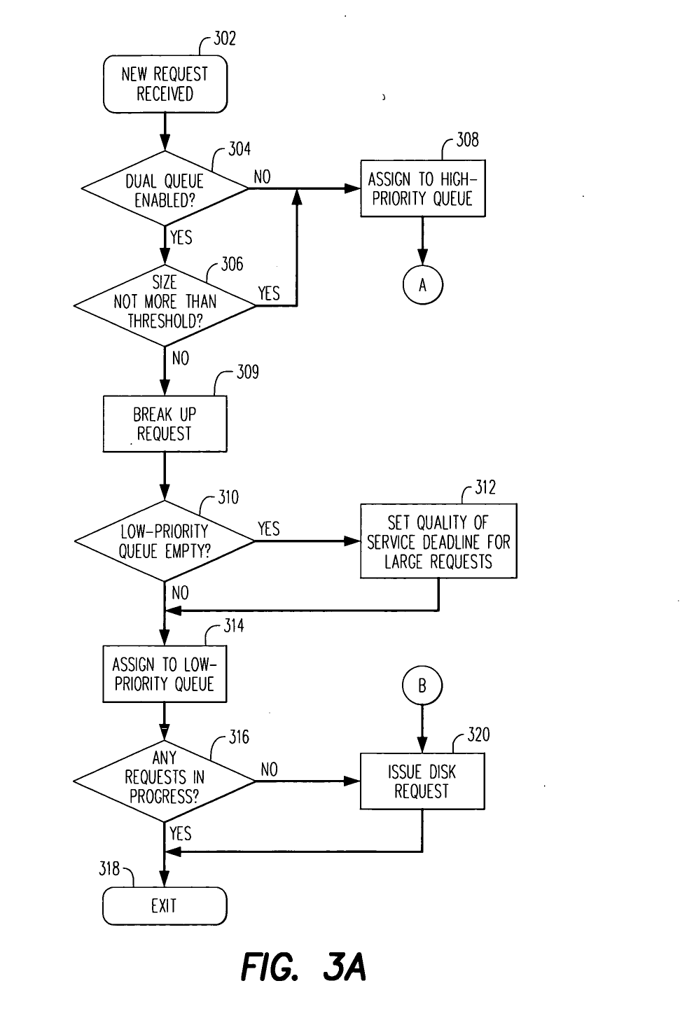

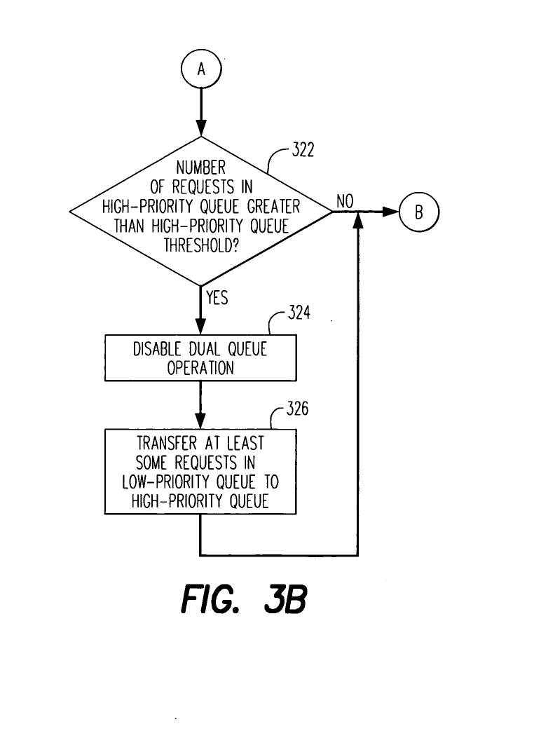

FIGS. 3A and 3B together form a flow chart that illustrates a queue-filling process that may be performed by the system 100. The process begins as indicated at 302 with receipt of a disk access request. Then, as indicated at 304, it is determined whether the dual queue scheme represented in FIG. 2 is currently enabled. If so, then it is determined at 306 whether the size of the request does not exceed the request size threshold (which may, as noted above, be 128 KB). If the request size does not exceed the threshold, then 308 follows, at which the request is assigned to the high-priority queue 204.

If at 306 it is determined that the request size exceeds the threshold, then, at 309, the request is broken up into smaller requests, and it is next determined at 310 whether the low-priority queue is empty. If so, as indicated at 312 the quality of service deadline for large requests is set to occur at a certain time interval after the current time. (In some embodiments, the length of the time interval may be configurable or tunable to allow the user and/or programmer to vary the degree of anti-starvation protection accorded to large disk access requests.) Following 312 is 314, at which the large request is assigned to the low-priority queue 206. In some embodiments, each large request is broken up into smaller (e.g., no greater than 128 KB) requests and the resulting smaller requests are assigned to the low-priority queue, thereby effectively assigning the original large request to the low-priority queue.

Considering again the decision at 310, if it is determined that the low-priority queue is not empty, then the assignment (314) of the large request to the low-priority queue (e.g., in broken-up form) occurs without the quality of service deadline for large requests being set at this time.

Thus, in effect, the portion of the process of FIGS. 3A-3B, as discussed up to this point, assigns newly received disk drive access requests either to the high-priority queue or to the low-priority queue, depending on the size of the request, with the smaller requests being assigned to the high-priority queue. As suggested above, the threshold for determining the queue assignment may be set at 128 KB, which may be the maximum size of requests that are typically generated by office application software. Thus, by giving preference to requests assigned to the high-priority queue, task completion by office application software may be expedited, even when a disk-access-intensive application is executing in background. This advantage may be particularly relevant to a home computer that is used both for office-type data processing tasks and for home media information management and media device control purposes.

After 314, it is determined at 316 whether there are currently any requests in progress (i.e., whether any requests have been taken in to the drive queue 208 (FIG. 2) and not yet completed). If so, then the process exits (318). However, if it is determined at 316 that there are no requests in progress, then a function is called (320) to issue a request to the disk drive so that at least one of the queues 204, 206 is serviced.

Considering again the stage 308 at which a small request may be assigned to the high-priority queue, it is next determined (322, FIG. 3B) whether the number of requests currently in the high-priority queue awaiting servicing is greater than a high-priority queue threshold. In some embodiments, the threshold value for this purpose may be 64. If the number of requests in the high-priority queue exceeds the threshold, then the dual queue operation is disabled (324), and all requests in the low-priority queue are transferred (326) to the high-priority queue. In other embodiments, only some requests in the low-priority queue are transferred to the high-priority queue. (The high priority queue may be re-sorted at this time to promote efficiency in the resulting disk drive access operations, e.g., to minimize seek operations and/or rotational latency. Indeed, any time a request is added to a queue, the queue in question may be re-sorted for this purpose.)

The effect of stages 322, 324, 326 is to combine all requests in one queue when the number of small requests at a given time is relatively large. This may tend to promote the most efficient operation at such times. Under such circumstances, large requests may be assigned to the high priority queue.

Following 326, the process advances to 320 (FIG. 3A), discussed above, at which a request is issued to the disk drive. Alternatively, if it is determined at 322 that the number of requests in the high-priority queue does not exceed the high-priority queue threshold, then the process advances to 320 without disabling dual queue operation and without transferring the low-priority queue contents to the high-priority queue.

Considering again the decision made at 304 (FIG. 3A), if it is determined at that point that the dual queue operation had been disabled, then the newly received disk access request is assigned (308) to the high priority queue 204 regardless of the size of the request.

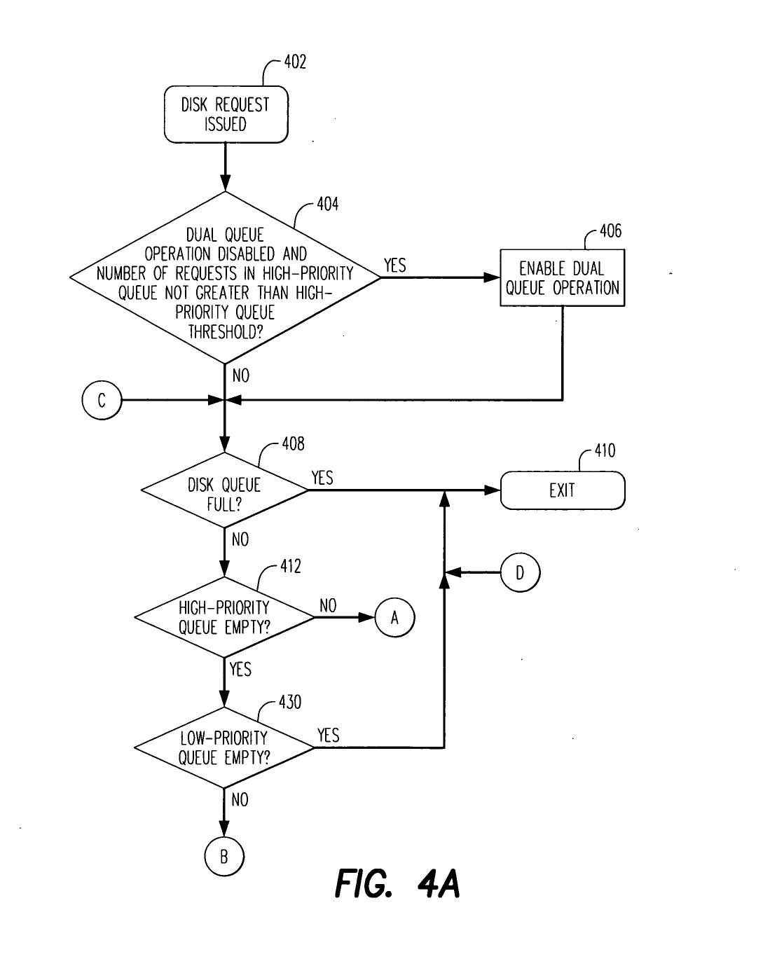

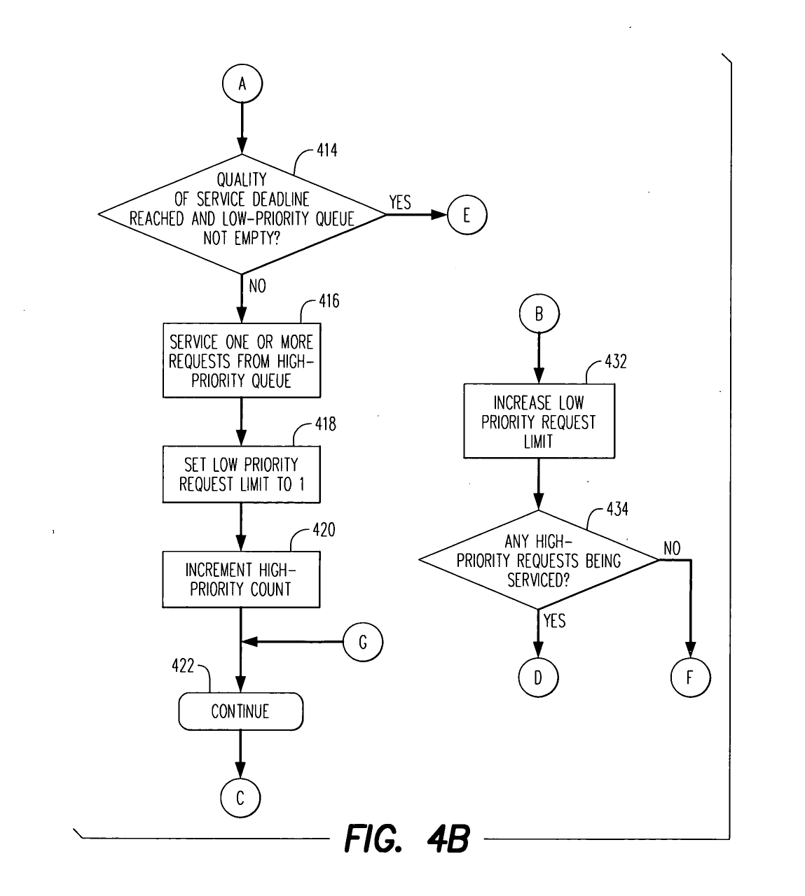

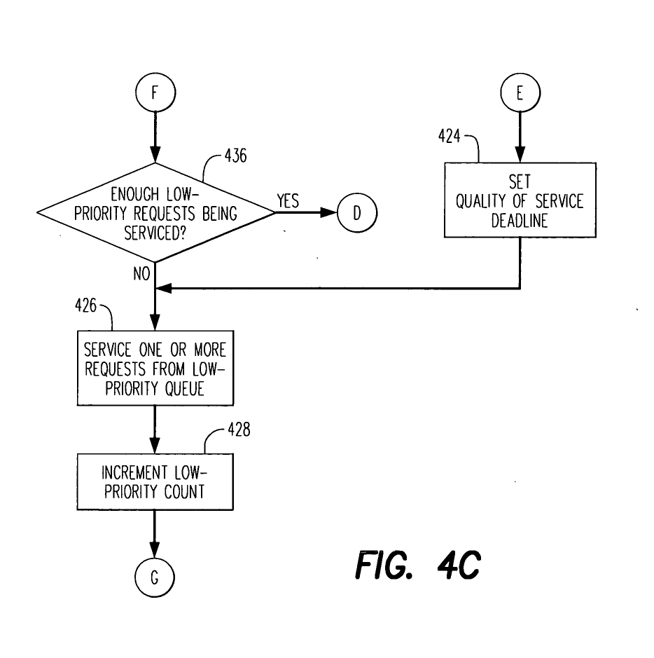

FIGS. 4A-4C together form a flow chart that illustrates a queue-servicing process that may be performed by the system 100.

The process of FIGS. 4A-4C begins at 402 with the function called to issue a disk request. Next, at 404, it is determined whether two conditions are satisfied, namely (a) the dual queue operation currently stands disabled, and (b) the number of requests in the high-priority queue is not greater than the high-priority queue threshold. If both conditions are satisfied, then 406 follows. At 406, the dual queue operation is again enabled.

Following 406 (or directly following 404 if either one of the conditions is not satisfied), a determination 408 is made as to whether the internal queue for the disk drive is full. If such is the case, the process exits (410).

If it is determined at 408 that the internal disk drive queue is not full, then a determination 412 is made as to whether the high-priority queue is empty. If the high-priority queue is not empty, then the process advances to a determination 414 (FIG. 4B). At 414, it is determined whether (a) the quality of service deadline has been reached, and (b) the low-priority queue is not empty. If either the quality of service deadline has not been reached or the low-priority queue is empty, then 416 follows. At 416, the request at the head of the high-priority queue 204 is serviced. Servicing of the request may first include adding the request to the drive queue 208. Thereafter, the request may reach the head of the drive queue and may be further serviced by performing the requested disk drive access, including storing or retrieving data in or from the disk drive 120.

Following 416 is 418. At 418 the low priority request limit is set to 1 (reflecting that there is activity in the high-priority queue). As will be seen, the low priority request limit defines the maximum number of low priority requests that may currently be pending on the drive queue or otherwise be in progress. This tends to assure prompt service for new high priority requests by making sure that the slots in the drive queue are not all occupied by low priority requests.

Following 418 is 420. At 420 the high priority count is incremented. The process then continues (422) including looping back to the determination at 408 (FIG. 4A), etc.

Considering again the determination made at 414, if it is found at that point that the quality of service deadline for large requests has been reached and the low-priority queue is not empty, then the process branches to 424 (FIG. 4C). At 424 the quality of service deadline is set to a time in the future that is a predetermined time interval away (as in 312, FIG. 3A). Also, at 426, the request at the head of the low-priority queue 206 is serviced. As in the case of servicing requests from the high-priority queue, servicing the low priority request may include first adding it to the drive queue 208 and then performing the requested disk drive access.

Following 426 is 428. At 428 the low priority count is incremented. The process then continues (422), loops back to the determination at 408 (FIG. 4A), etc.

Considering again the determination made at 412, if the high-priority queue is determined to be empty, then a determination at 430 is made. At 430, it is determined whether the low-priority queue is currently empty. If so, the process exits 410. However, if at 430 it is determined that the low-priority queue is not empty, then the process advances to 432 (FIG. 4B). At 432, the low-priority request limit is increased (in view of the fact that the high-priority queue is currently empty). At 434 it is determined whether there are any high-priority requests that are currently being serviced (i.e., high priority requests that have been taken into the drive queue and not yet completed). If so, the process exits (410, FIG. 4A). However, if it is determined at 434 that no high priority requests are currently being serviced, then the process advances to 436 (FIG. 4C).

At 436, it is determined whether the number of low priority requests currently being serviced (previously taken in to the drive queue and not yet completed) is as great as the low priority request limit. If so, then the process exits (410, FIG. 4A). However, if the number of low priority requests currently being serviced (if any) is not as great as the low priority request limit, then the process advances through 426, 428, etc. (FIG. 4C), with the next request in the low priority queue being serviced and the low priority count being incremented.

It will be observed that the over-all effect of 412, 414, 416, 430, 426, etc. is to give preference to the high-priority queue over the low-priority queue except to the extent that the quality of service deadline for large requests comes into play. Thus, small requests are given preference relative to large requests and are provided with an improved quality of service while large requests still receive an adequate quality of service. It will be appreciated that the disk drive may take much longer to service a large request than a small request. Thus the adverse effect on a large request of waiting for a small request to be completed may be much less than the adverse effect on a small request of waiting for a large request to be completed. In total, the algorithms described herein reprioritize input/output scheduling to promote fairness for small and/or random I/O requests, and good quality of service for all I/O requests in general.

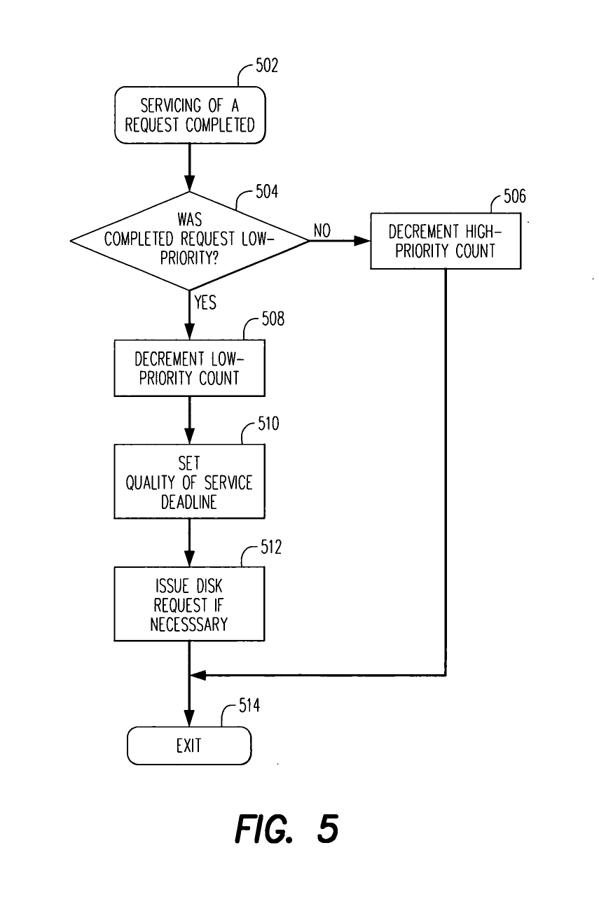

FIG. 5 is a flow chart that illustrates a process for responding to completion of servicing of a disk drive access request. The process begins at 502 with receipt of an indication (e.g., from the disk drive 120) that servicing of a disk drive access request has been completed. Then, at 504, it is determined whether the just-completed disk drive access request was high priority (i.e., from the high-priority queue) or low priority (i.e., from the low-priority queue). If it is determined at 504 that the just-completed request was high priority, the high priority count is decremented (506). (It will be recalled that the high priority count was previously incremented at 420—FIG. 4B.) On the other hand, if it is determined at 504 that the just-completed request was low priority, the low priority count is decremented (508). (It will be recalled that the low priority count was previously incremented at 428—FIG. 4C. The low priority count may be useful for making the determination at 436. The high priority count may be useful for making the determination at 434.) In addition, at 510, the quality of service deadline is set (as in 424, FIG. 4C; or 312, FIG. 3A), and if necessary a disk request is issued (512). Following either 506 or 512, as the case may be, the process of FIG. 5 exits (514).

As noted above, the functionality indicated by FIGS. 2-5 may be included in driver software that runs on a microprocessor to handle operation of a disk drive. In addition or alternatively, some or all of the functionality may be included in an operating system and/or in the software or firmware for the disk drive itself.

The flow charts and the above description are not intended to imply a fixed order for performing the stages of the processes described herein; rather, the process stages be performed in any order that is practicable. For example, the stages at 416, 418, 420 may be performed in any order, and the indicated order of 426, 428 may be reversed.

In an example embodiment described above, all requests smaller than or equal in size to a threshold are assigned to a high-priority queue and all requests that are larger than the threshold are assigned to a low-priority queue. However, in other embodiments, three or more queues may be employed. For instance, requests having a size equal to a 4K page may be assigned to a first, highest-priority queue. Other requests having a size equal to or less than a threshold may be assigned to a second queue that is next in priority, and requests having a size larger than the threshold may be assigned to a third queue that is lowest in priority. As an alternative or supplement to assigning requests to queues based on the size of the requests, the assignments may be made on other bases, such as where on the disk the requested information is located. For example, if a large request is located between two small requests on the disk, the large request may be assigned ahead of the second small request.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A method comprising:
receiving a request to access a disk drive, the request having a size;
selecting a queue, based at least in part on the size of the request, from among a plurality of queues; and
assigning the request to the selected queue.

2. The method of claim 1, wherein the assigning includes:
assigning the request to a first queue if the size of the request does not exceed a threshold; and
assigning the request to a second queue if the size of the request exceeds the threshold.

3. The method of claim 2, further comprising:
servicing the first queue in preference to servicing the second queue.

4. The method of claim 3, further comprising:
interrupting servicing of the first queue at a predetermined time interval to service a request from the second queue.

5. The method of claim 3, wherein servicing one of the first and second queues includes assigning a request from said one of the queues to a third queue.

6. The method of claim 5, further comprising:
limiting to a predetermined amount a number of requests from the second queue currently assigned to the third queue.

7. The method of claim 6, further comprising:
increasing the predetermined limit amount during a period in which no requests are received that have a size that does not exceed the threshold.

8. The method of claim 7, further comprising:
reducing the predetermined limit amount to a minimum value upon receiving a request that has a size that does not exceed the threshold.

9. The method of claim 5, further comprising:
assigning all requests in said second queue to said first queue if a number of requests in said first queue exceeds a first queue threshold.

10. The method of claim 2, wherein, if the size of the request exceeds the threshold, assigning the request to the second queue includes dividing the request into a plurality of requests and assigning the plurality of requests to the second queue.

11. An apparatus comprising:
a processor; and
a memory coupled to the processor and storing instructions operative to cause the processor to:
receive a request to access a disk drive, the request having a size;
assign the request to a first queue if the size of the request does not exceed a threshold; and
assign the request to a second queue if the size of the request exceeds the threshold.

12. The apparatus of claim 11, wherein the instructions are further operative to cause the processor to:
service the first queue in preference to servicing the second queue.

13. The apparatus of claim 12, wherein the instructions are further operative to cause the processor to:
interrupt servicing of the first queue at a predetermined time interval to service a request from the second queue.

14. The apparatus of claim 13, wherein servicing one of the first and second queues includes assigning a request from said one of the queues to a third queue.

15. The apparatus of claim 14, wherein the instructions are further operative to cause the processor to:
limit to a predetermined amount a number of requests from the second queue currently assigned to the third queue.

16. The apparatus of claim 15, wherein the instructions are further operative to cause the processor to:
increase the predetermined limit amount during a period in which no requests are received that have a size that does not exceed the threshold.

17. A system comprising:
a processor;
a chipset coupled to the processor; and
a memory coupled to the processor and storing instructions operative to cause the processor to:
receive a request to access a disk drive, the request having a size;
assign the request to a first queue if the size of the request does not exceed a threshold; and
assign the request to a second queue if the size of the request exceeds the threshold.

18. The system of claim 17, wherein the instructions are further operative to cause the processor to:
service the first queue in preference to servicing the second queue.

19. The system of claim 18, wherein the instructions are further operative to cause the processor to:
interrupt servicing of the first queue at a predetermined time interval to service a request from the second queue.

20. An apparatus comprising:
a storage medium having stored thereon instructions that when executed by a machine result in the following:
receiving a request to access a disk drive, the request having a size;
assigning the request to a first queue if the size of the request does not exceed a threshold; and
assigning the request to a second queue if the size of the request exceeds the threshold.

21. The apparatus of claim 20, wherein the instructions, when executed by the machine, further result in:
servicing the first queue in preference to servicing the second queue.

22. The apparatus of claim 21, wherein the instructions, when executed by the machine, further result in:
interrupting servicing of the first queue at a predetermined time interval to service a request from the second queue.
